(19) United States
(12) Patent Application Publication
(10) Pub. No.: US 2014/0080101 A1
(43) Pub. Date: Mar. 20, 2014

(54) KIT FOR FORMING PRINTED MESSAGE CARD WITH DISPLAYED ORIGAMI STRUCTURE AND PRINTED MESSAGE CARD FORMED USING SAME

(71) Applicants: David Odell Simmons, Austin, TX (US); David Lloyd Simmons, Austin, TX (US)

(72) Inventors: David Odell Simmons, Austin, TX (US); David Lloyd Simmons, Austin, TX (US)

(21) Appl. No.: 13/621,267

(22) Filed: Sep. 16, 2012

(51) Int. Cl. G09B 19/00

(52) U.S. Cl. CPC G09B 19/00
USPC 434/82

(57) ABSTRACT

A kit comprises a plurality of printed message cards, a plurality of envelopes, a plurality of sheets of material each from which an instance of an origami structure can be formed, and an article having instructions thereon for creating the instance of the origami structure using one of the sheets of material. Each one of the envelopes has a space for receiving one of the printed message cards.

### FIELD OF THE DISCLOSURE

The disclosures made herein relate generally to printed message cards and, more particularly, to a kit for forming a printed message card with displayed origami structure.

### BACKGROUND

Printed message cards, also known as greeting cards, are very popular throughout the world. A typical printed message card is made from a piece of paper stock and usually has a pre-printed message or picture on it. They are used to send messages, to congratulate someone on their achievements or to celebration a special occasion. Examples of such a special occasion include, but are not limited to, Christmas, Thanksgiving, a Birthday, New Years Day, Fourth of July, Easter, Halloween, Hanukkah, etc.

In many instances, a person sends a card with the same design to multiple recipients. An example of this occasion is on Christmas when a single person or their family sends their Christmas cards of the same designs to friends and family. Another example of this occasion is, when a single person or their family is sending party invitation cards with the same design to friends and family.

### SUMMARY OF THE DISCLOSURE

In one embodiment of the present invention, a kit comprises an article having instructions for creating an origami structure from a sheet of material and a plurality of printed message cards. Each one of the printed message cards includes a first flap and a second flap. The first flap includes an opening in the shape of an outline of the origami structure.

In another embodiment of the present invention, a kit comprises a plurality of printed message cards, a plurality of envelopes, a plurality of sheets of material each from which an instance of an origami structure can be formed, and an article having instructions thereon for creating the instance of the origami structure using one of the sheets of material. Each one of the envelopes has a space therein for receiving one of the printed message cards.

In another embodiment of the present invention, a printed message card assembly comprises an origami structure and a printed message card. The printed message card includes a first flap and a second flap. The first flap includes an opening in the shape of an outline of the origami structure. The origami structure is positioned within the opening.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is an illustrative view of a kit configured in accordance with an embodiment of the present invention.

FIGS. 2A and 2B are illustrative views of an instruction article of the kit of FIG. 1

FIG. 3 is a perspective view of a printed message card configured in accordance with an embodiment of the present invention.

FIG. 4 is a perspective view of a printed message card assembly configured in accordance with an embodiment of the present invention.

FIG. 5 is a cross-sectional view showing an arrangement of an origami structure within an origami structure display opening of the printed message card assembly of FIG. 4 when a first flap thereof is in a closed orientation with respect to a second flap thereof

FIG. 6 is a cross-sectional view of a printed message card assembly configured in accordance with a second embodiment of the present invention, showing an arrangement of an origami structure within an origami structure display opening of the printed message card assembly when a first flap thereof is in a closed orientation with respect to a second flap thereof

### DETAILED DESCRIPTION OF THE DRAWING FIGURES

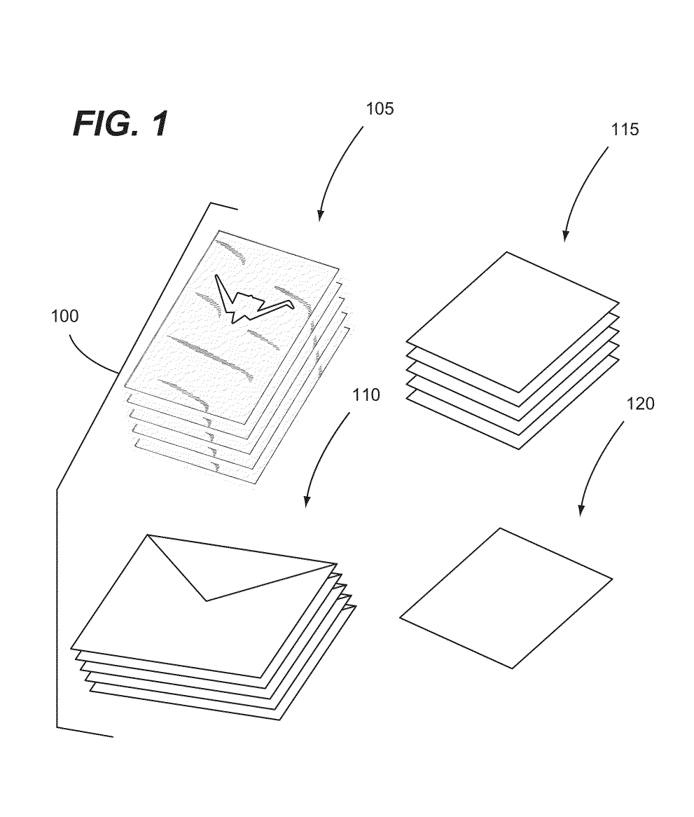

FIG. 1 shows an embodiment of a kit 100 configured in accordance with an embodiment of the present invention. The kit 100 is configured for forming a printed message card with displayed origami structure. Such a printed message card with displayed origami structure is an example of a printed message card assembly configured in accordance with an embodiment of the present invention. In this regard, through use of the kit 100, a printed message card assembly configured in accordance with the present invention can be fabricated.

The kit 100 includes a plurality of printed message cards 105, a plurality of envelopes 110, a plurality of sheets of material 115, and an instruction article 120. Each one of the envelopes 110 has a space therein for receiving one of the printed message cards 105. Sheets of paper and sheets of fabric are two examples of the sheets of material 115. An instance of an origami structure can be formed from each one of the sheets of material 115. The instruction article 120 has instructions thereon for creating the instance of the origami structure using one of the sheets of material 115.

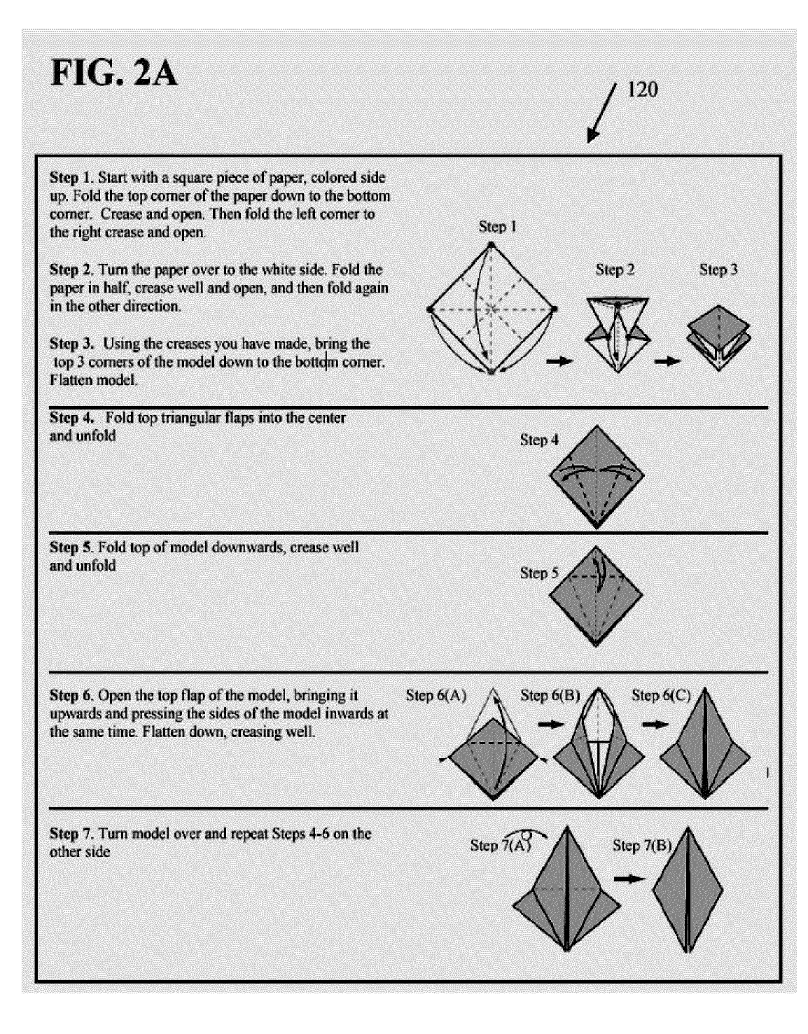

An example of the instruction article 120 is shown in FIGS. 2A and 2B. Instructions provided on the instruction article 120 are configured for teaching a person to make an origami structure in the form of a Crane (i.e., a bird). The present invention is not limited to any particular origami structure. Origami structures of various forms are well known. Examples of such known origami structures include, but are not limited to, flowers, animals, airplanes, toys, stars, geometric shapes, and the like.

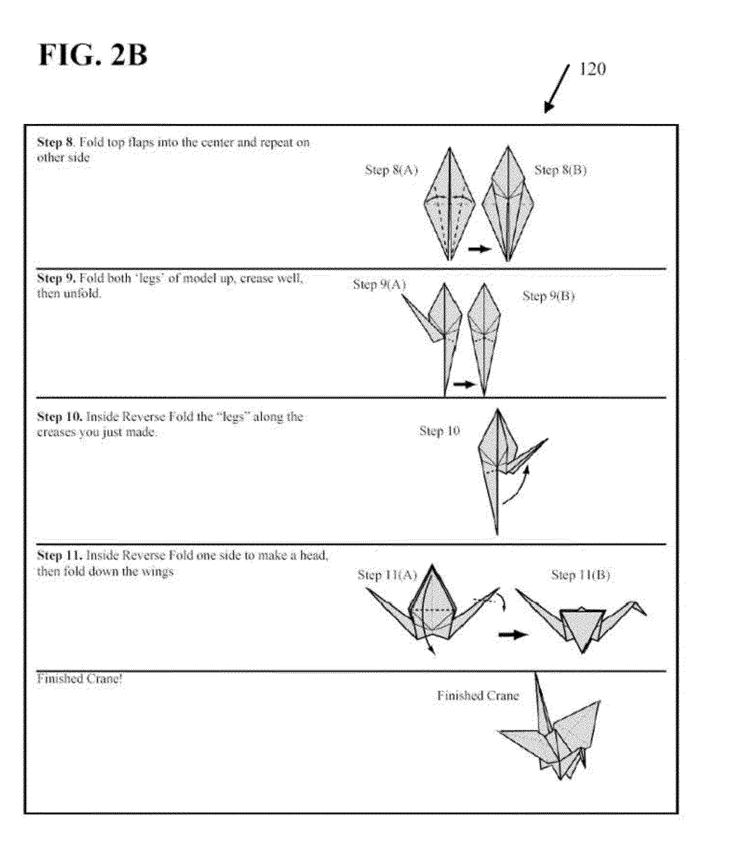

Referring now to FIG. 3, each one of the printed message cards 105 has a first (e.g., front) flap 122 and a second (e.g., rear) flap 124. The first flap 122 can be a front flap and the second flap 124 can be a rear flap. Alternatively, the second flap 124 can be an interior flap such as that of a tri-folded printed message card. Similarly, the first flap 122 can be an interior flap and the second flap 124 can be a rear flap.

As shown in FIG. 3, the first flap 122 can include opening 126 in the shape of an outline of the origami structure formed using the article instructions. In this regard, the opening 126 is an origami structure display opening. Preferably, each one of the sheets of material 115 has a length dimension and a width dimension such that folding one of the sheets of material 115 in accordance with the instruction provided on the instruction article 120 without altering the length dimension or the width dimension results in formation of the origami structure of a size allowing the origami structure to fit inside the opening 126 in the first flap. Alternatively, the opening 126 can be in an interior flap of a printed message card configured in accordance with an embodiment of the present invention. Furthermore, it is disclosed herein that a plurality of origami structure display opening can be provided in a flap of a printed message card configured in accordance with an embodiment of the present invention. For example, the plurality of origami structure display openings can be in the form of a collage of origami structures (e.g., a bouquet of flowers, a collection of similar or different forms of origami structures, etc). In such an implementation of the present invention, a printed message card assembly can include an origami structure unit including a plurality of origami structures interconnected such as with wires, ribbon, string, or other suitable interconnecting structure. Still further, the printed message card can include printed indicia that visually depicts scenery associated with a single origami structure display opening or a plurality of origami structure display openings (e.g., a vine, a flower pot with stems, a scene depicting an environment corresponding to the origami structures, or the like).

A kit configured in accordance with an embodiment of the present invention can include a plurality of origami structure holders. Each one of the origami structure holders can be configured to be attached to a respective one of the printed message cards 105 and for allowing having an origami structure attached thereto. For example, the origami structure holder can be a plastic mount that has a first portion configured for being attached to one of the printed message card 105 and a second portion configured for having the origami structure attached thereto (e.g., hung on).

It is disclosed herein that each one of the printed message cards 105 can be integral with a respective one of the printed message cards 105. For example, each one of the printed message cards 105 can include a die cut shape therein allowing such shape to be folded outward and thereby serve as an origami structure holder on which the origami structure can be attached (e.g., hung).

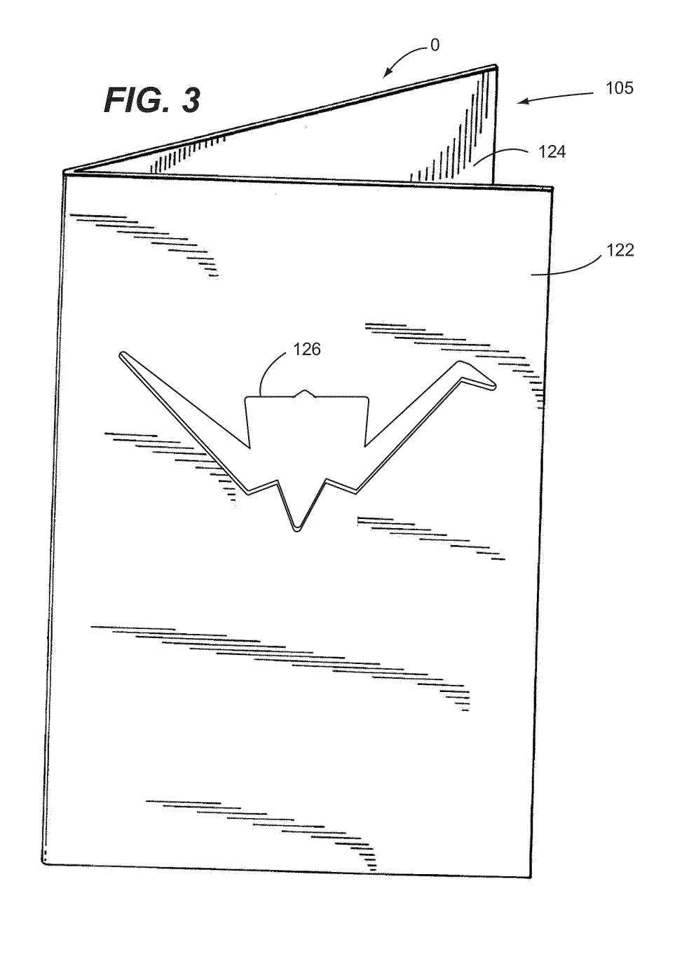

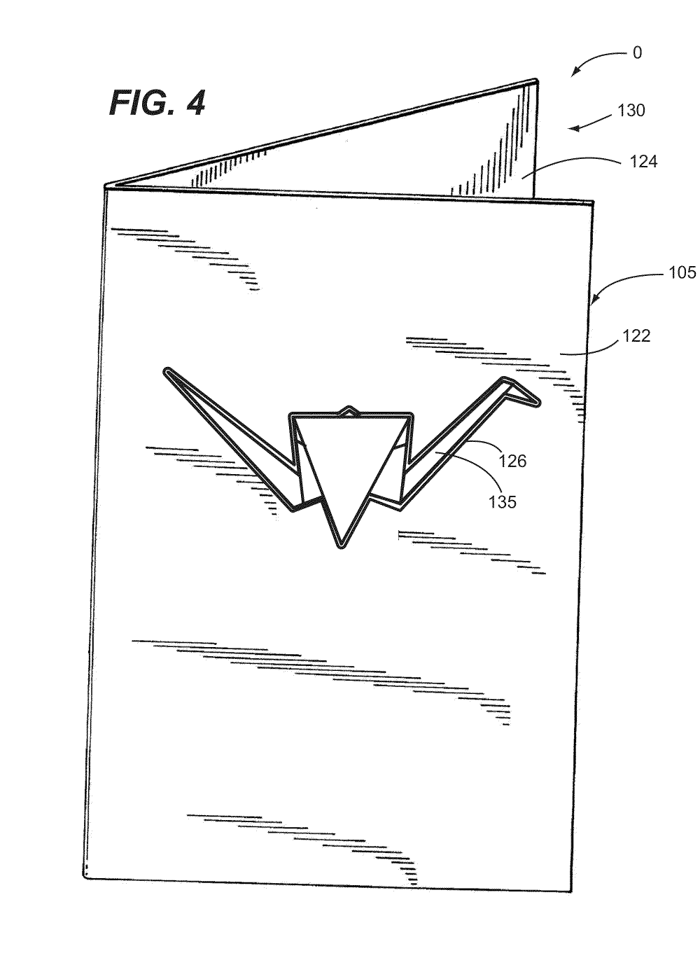

Referring now to FIGS. 4 and 5, a printed message card assembly 130 configured in accordance with a first embodiment of the present invention is shown. The printed message card assembly 130 includes one of the printed message cards 105 (i.e., the printed message card 105) and an origami structure 135 (i.e., an origami crane). For example, the origami structure 135 is formed using one of the pieces of material 115 in accordance with the instructions provided on the instruction article 120. The origami crane 135 is secured to the first flap 122 such that the origami crane 135 is positioned within the opening 126 when the first flap 122 is in an open orientation O (FIG. 4) with respect to the second flap 124 and when the first flap 122 is in a closed orientation C (FIG. 5) with respect to the second flap 124. The first flap 122 includes an origami structure securing article 140 for securing the origami structure 135 in the opening 126. Examples of the origami structure securing article 140 include, but are not limited to, a piece of tape extending behind the opening 126, a clip for mechanically holding the origami structure, a clip for mechanically holding a string or ribbon attached to the origami structure 135, a clear plastic sleeve that slides over the first flap 122, one or more cut-outs in the first flap 122 that are engaged a respective portion of the origami structure 135, or any other suitable means for securing the origami structure 135 within the opening 126 when the first flap 122 is in the open orientation O and the closed orientation C. Furthermore, embodiments of the present invention are not limited to any particular means for securing the origami structure 135 within the opening 126 when the first flap 122 is in the open orientation O and the closed orientation C.

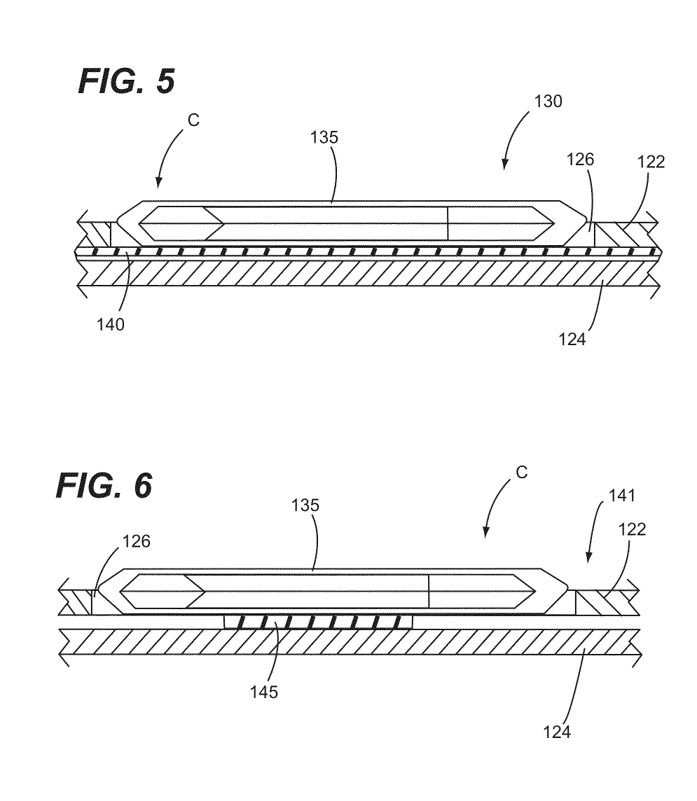

FIG. 6 shows a printed message card assembly 141 configured in accordance with a second embodiment of the present invention. The printed message card assembly 141 includes one of the printed message cards 105 (i.e., the printed message card 105) and the origami structure 135. The origami crane 135 is secured to the second flap 124 such that the origami crane 135 it is positioned within the opening 126 when the first flap 122 is in a closed orientation C (shown in FIG. 5) with respect to the second flap 124 and remains attached to the second flap 124 when the first flap 122 is in the open orientation O (shown in FIG. 4) with respect to the second flap 124. The second flap 124 includes an origami structure securing article 145 for securing the origami structure 135 thereto when the first flap 122 is in the open orientation O with respect to the second flap 124. Examples of the origami structure securing article 145 include, but are not limited to, a piece of double-sided tape, a clip for mechanically holding the origami structure, a clip for mechanically holding a string or ribbon attached to the origami structure 135, a clear plastic sleeve that slides over the second flap 124, one or more cut-outs in the second flap 124 that are engaged a respective portion of the origami structure 135, or any other suitable means for means for securing the origami structure 135 to the second flap 124 when the first flap 122 is in the open orientation O. Furthermore, embodiments of the present invention are not limited to any particular means for securing the origami structure 135 to the second flap 124 when the first flap 122 is in the open orientation O.

It is disclosed herein that a printed message card of a kit configured in accordance with the present invention need not have an opening for having an origami structure positioned therein. Advantageously, a printed message card can have an origami structure mounted on a surface thereof or attached thereto. The underlying uniqueness of such a kit is maintained in that a user is able to create a handmade origami structure for inclusion with a printed message card. For example, the origami structure can be attached via an adhesive implement, a clear plastic sleeve that slides over one of the flaps of the printed message card, or other suitable attachment means.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A kit, comprising:
an article having instructions for creating an origami structure from a sheet of material; and
a plurality of printed message cards, wherein each one of the printed message cards includes a first flap and a second flap, and wherein the first flap includes an opening in the shape of an outline of the origami structure.

2. The kit of claim 1, further comprising:
a plurality of sheets of material from which a plurality of the origami structure can be formed.

3. The kit of claim 2 wherein:
each one of the sheets of material has a length dimension and a width dimension such that folding one of the sheets of material in accordance with instruction of the instruction article without altering the length dimension or the width dimension results in formation of the origami structure of a size allowing the origami structure to fit inside the opening in the first flap.

4. The kit, of claim 1 wherein:
each one of the printed message cards includes an origami structure securing article on the second flap thereof; and
the origami structure securing article is exposed within the opening when the first flap is in a closed orientation relative second flap.

5. The kit of claim 4, further comprising:
a plurality of sheets of material from which a plurality of the origami structure can be formed;
wherein each one of the sheets of material has a length dimension and a width dimension such that folding one of the sheets of material in accordance with instruction of the instruction article without altering the length dimension or the width dimension results in formation of the origami structure of a size allowing the origami structure to fit inside the opening in the first flap.

6. The kit of claim 5 wherein:
the first flap is a front flap; and
the second flap is one of a rear flap and an interior flap.

7. The kit of claim 1 wherein each one of the printed message cards a means integral with the first flap thereof for securing the origami structure within the opening when the first flap is in an open orientation relative second flap.

8. The kit of claim 6, further comprising:
a plurality of sheets of material from which a plurality of the origami structure can be formed;
wherein each one of the sheets of material has a length dimension and a width dimension such that folding one of the sheets of material in accordance with instruction of the instruction article without altering the length dimension or the width dimension results in formation of the origami structure of a size allowing the origami structure to fit inside the opening in the first flap.

9. The kit of claim 5 wherein:
the first flap is a front flap; and
the second flap is one of a rear flap and an interior flap.

10. A kit, comprising:
a plurality of printed message cards;
a plurality of envelopes, wherein each one of the envelopes has a space for receiving one of the printed message cards;
a plurality of sheets of material each from which an instance of an origami structure can be formed; and
an article having instructions for creating the instance of the origami structure using one of the sheets of material.

11. The kit of claim 10 wherein:
each one of the printed message cards includes a first flap and a second flap; and
the first flap includes an opening in the shape of an outline of the origami structure.

12. The kit of claim 11 wherein:
the first flap is a front flap; and
the second flap is one of a rear flap and an interior flap.

13. The kit of claim 11 wherein each one of the sheets of material has a length dimension and a width dimension such that folding one of the sheets of material in accordance with instruction of the instruction article without altering the length dimension or the width dimension results in formation of the origami structure of a size allowing the origami structure to fit inside the opening in the first flap.

14. The kit of claim 11 wherein:
each one of the printed message cards includes an origami structure securing article on the second flap thereof; and
the origami structure securing article is exposed within the opening when the first flap is in a closed orientation relative second flap.

15. The kit of claim 11 wherein each one of the printed message cards a means integral with the first flap thereof for securing the origami structure within the opening when the first flap is in an open orientation relative second flap.

16. A printed message card assembly, comprising:
an origami structure; and
a printed message card, wherein the printed message card includes a first flap and a second flap, wherein the first flap includes an opening in the shape of an outline of the origami structure, and wherein the origami structure is positioned within the opening when the first flap is in a closed orientation relative to the second flap.

17. The printed message card assembly of claim 16 wherein:
the first flap is a front flap; and
the second flap is one of a rear flap and an interior flap.

18. The printed message card assembly, of claim 16 wherein:
each one of the printed message cards includes an origami structure securing article on the second flap thereof;
the origami structure securing article is located on the second flap; and
the origami structure is secured to the origami structure securing article such that the origami structure is positioned within the opening when the first flap is in a closed orientation relative to the second flap and remains secured to the origami structure securing article when the first flap is in an open orientation relative second flap.

19. The printed message card assembly of claim 16 wherein each one of the printed message cards a means integral with the first flap thereof for securing the origami structure within the opening when the first flap is in an open orientation relative second flap.

20. The printed message card assembly of claim 16 wherein:
the first flap is a front flap; and
the second flap is one of a rear flap and an interior flap.
